(19) United States
(12) Patent Application Publication
(10) Pub. No.: US 2014/0354616 A1
(43) Pub. Date: Dec. 4, 2014

(54) ACTIVE MATRIX DISPLAY, SCANNING DRIVEN CIRCUITS AND THE METHOD THEREOF

(71) Applicant: Shenzhen China Star Optoelectronics Technology Co., Shenzhen, Guangdong (CN)

(72) Inventors: Zuomin Liao, Shenzhen City (CN); Bing Han, Shenzhen City (CN)

(73) Assignee: Shenzhen China Star Optoelectronics Technology Co., Ltd., Shenzhen, Guangdong (CN)

(21) Appl. No.: 13/985,650

(22) PCT Filed: Jun. 28, 2013
(86) PCT No.: PCT/CN2013/078264

§ 371 Date: Aug. 15, 2013

(30) Foreign Application Priority Data
May 31, 2013 (CN) 2013102136143

(51) Int. Cl. G09G 3/36

(52) U.S. Cl. CPC G09G 3/3696
USPC 345/212; 345/87

(57) ABSTRACT

An active matrix display and the scanning driven circuit and method thereof are disclosed. The scanning driven circuit includes a PCBA, a scanning driven chip, and a VGH transmission line for transmitting the scanning driving signals from the PCBA to the scanning driven chip. The VGH transmission line includes an impedance unit to maintain a delay of the scanning driving signals at the front end substantially the same with the delay of the scanning driving signals at the rear end of the scanning line. In this way, the color shift effect of the active matrix display is improved.

### BACKGROUND OF THE INVENTION

1. Field of the Invention

The present disclosure relates to liquid crystal display (LCD) technology, and more particularly to an active matrix display and the scanning driven circuit and method thereof.

2. Discussion of the Related Art

Color shift is an important problem for active matrix displays. The main reason is that the path of the data lines corresponding to two lateral sides of the display panel is longer than that of the data lines corresponding to a central portion of the display panel. Under the circumstance, the impendence of the data lines at the lateral sides is larger than that at the central portion. The larger impendence cause the greater delay, and so does the color shift. On the other hand, the RC delay of the scanning lines cause a different charging rate of the pixels respectively arranged in a front end and a rear end of the scanning lines, which also contributes to the color shift.

FIG. 1 is a waveform diagram of one conventional active matrix display. As shown, the waveform of the scanning driven signals of the pixels arranged in the front end is labeled as 10. The waveform of the scanning driven signals of the pixels arranged in the rear end is labeled as 20, The waveform of the data driven signals of the data lines is labeled as 30. An ideal waveform of the data driven signals of the data lines is labeled as 40.

As shown in FIG. 1, the charging rate of the G pixel is lower than that of the R pixel and thus results in the color shift towards the yellow color. In addition, as the data driven signals and the scanning driven signals are delayed at the rear end of the scanning lines, the charging time of the G pixel is prolonged and thus the charging rate of the pixel G arranged at the rear end is higher than that arranged at the front end. As a result, the color shift effect is more obvious at the front end of the scanning lines. However, as the delay of the data lines is difficult to resolve, and thus a solution to improve the color shift effect caused by the scanning lines is needed.

### SUMMARY

The object of the invention is to provide an active matrix display and the scanning driven circuit and method thereof to improve the color shift effect.

In one aspect, a scanning driven circuit for providing scanning driven signals to scanning lines of an active matrix display includes: a printed circuit board assembly (PCBA); a scanning driven chip; a voltage high (Val) transmission line for transmitting the scanning driving signals from the PCBA to the scanning driven chip; and wherein the Will transmission line includes an impedance unit to maintain a delay of the scanning driving signals at the front end substantially the same with the delay of the scanning driving signals at the rear end of the scanning line.

Wherein the impedance unit is arranged on the VGH transmission line within the PCBA.

Wherein the impedance unit is arranged on the VGH transmission line between the PCBA and the scanning driven chip.

Wherein the impedance unit is arranged on the VGH transmission line within the scanning driven chip.

Wherein the impedance unit is a circuit having at least one resistor, and the resistance value of the resistor is larger than the resistor of the scanning lines.

Wherein the impedance unit is a circuit having at least one capacitor, and the capacitance value of the capacitor is larger than the capacitor of the scanning lines.

Wherein the impedance unit includes at least one resistor and at least one capacitor, and a product of the resistor and the capacitor of the impedance unit is larger than that of the resistor and the capacitors of the scanning line.

In another aspect, an active matrix display includes a scanning driven circuit for providing scanning driven signals to scanning lines of an active matrix display. The scanning driven circuit includes: a PCBA; a scanning driven chip; a VGH transmission line for transmitting the scanning driving signals from the PCBA to the scanning driven chip; and wherein the VGH transmission line includes an impedance unit to maintain a delay of the scanning driving signals at the front end substantially the same with the delay of the scanning driving signals at the rear end of the scanning line.

Wherein the impedance unit is arranged on the VGH transmission line within the PCBA.

Wherein the impedance unit is arranged on the VGH transmission line between the PCBA and the scanning driven chip.

Wherein the impedance unit is arranged on the VGH transmission line within the scanning driven chip.

Wherein the impedance unit is a circuit having at least one resistor, and the resistance value of the resistor is larger than the resistor of the scanning lines.

Wherein the impedance unit is a circuit having, at least one capacitor, and the capacitance value of the capacitor is larger than the capacitor of the scanning lines.

Wherein the impedance unit includes at least one resistor and at least one capacitor, and a product of the resistor and the capacitor of the impedance unit is larger than that of the resistor and the capacitors of the scanning line.

In another aspect, a scanning driven method includes: providing scanning driven signals to a VGH transmission line; delaying the scanning driven signals when the scanning driven signals are transmitted by the VGH transmission line; and transmitting the delayed scanning driven signals to the scanning lines such that the delay of the scanning driven signals at the front end is substantially the same with that of the scanning driven signals at the rear end of the scanning lines.

Wherein the delaying step further includes arranged an impedance unit on the VGH transmission line.

Wherein the impedance unit includes at least one resistor and at least one capacitor, and a product of the resistor and the capacitor of the impedance unit is larger than that of the resistor and the capacitors of the scanning line.

### BRIEF DESCRIPTION OF THE DRAWINGS

FIG. 1 is a waveform diagram of one conventional active matrix display.

FIG. 2 is a schematic view of the active matrix display including the scanning driven circuit in accordance with a first embodiment.

FIG. 3 is an equivalent circuit of the impedance unit and the scanning line of the scanning driven circuit in accordance with the first embodiment.

FIG. 4 is a waveform diagram of the active matrix display of FIG. 2.

FIG. 5 is a flowchart of the scanning driven method in accordance with a second embodiment.

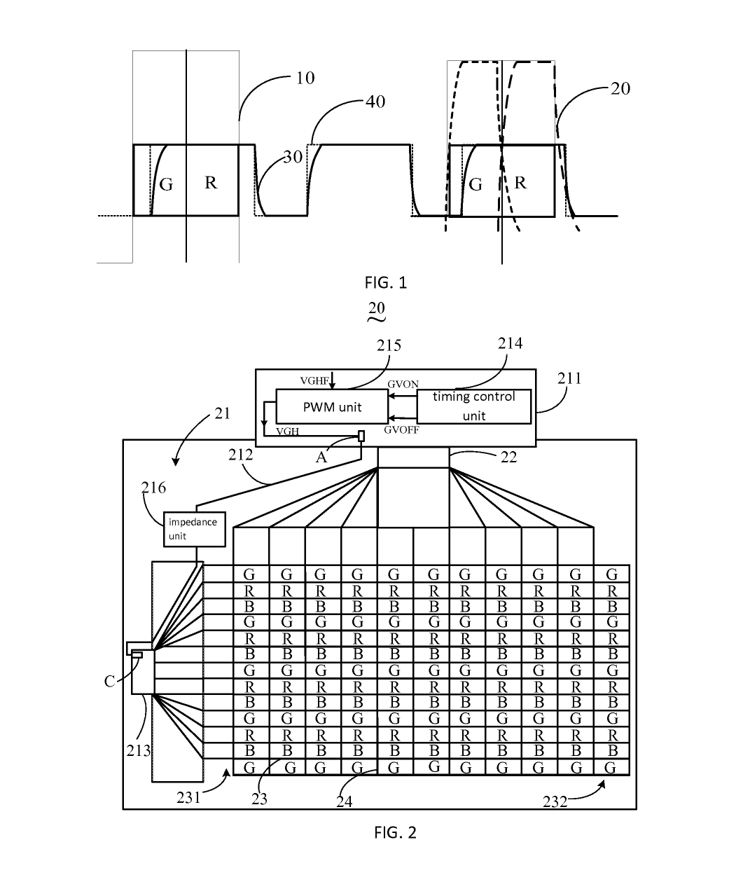

### DETAILED DESCRIPTION OF THE EMBODIMENTS

Embodiments of the invention will now be described more fully hereinafter with reference to the accompanying drawings, in which embodiments of the invention are shown.

FIG. 2 is a schematic view of the active matrix display including the scanning driven circuit in accordance with a first embodiment. As shown in FIG. 2, the active matrix display 20 includes a scanning driven circuit 21, a data driven chip 22, a plurality of scanning lines 23, and a plurality of data lines 24.

The scanning driven circuit 21 provides the scanning driven signals for the scanning lines 23 of the active matrix display 20. The scanning driven circuit 21 includes a printed circuit board assembly (PCBA) 211, a turn-on voltage (Voltage High, VGH) transmission line 212, and a scanning driven chip 213. The PCBA 211 includes a timing control unit 214 and a pulse width modulation (PWM) unit 215.

In one embodiment, the timing control unit 214 couples with the PWM unit 215. One end of the NIGH transmission line 212 couples with the PWM unit 215 within the PCBA 211, and the other end of the VGH transmission line 212 couples with the scanning driven chip 213. An output of the scanning driven chip 213 couples with the scanning lines 23, and an output of the data driven chip 22 couples with the data lines 24.

The timing control unit 214 generates control signals (GVON/GVOFF) for the PWM unit 215. The PWM unit 215 receives the voltage (VGHF) from the PCBA 211 and the control signals from the timing control unit 214, and then modulates and outputs the scanning driven signals, that is, the turn-on signals. The VGH transmission line 212 transmits the scanning driven signals output from the PWM unit 215 to the scanning driven chip 213, and then further transmits the scanning driven signals to the R, G, and B pixels via the scanning lines 23.

In one embodiment, the VGH transmission line 212 further includes an impedance unit 216 to maintain the delay of the scanning driven signals at the front end 231 substantially the same with that of the scanning signals at the rear end 232 of the scanning lines 23. Specifically, the impedance unit 216 is arranged on the VGH transmission line 212 between the PCBA 211 and the scanning driven chip 213.

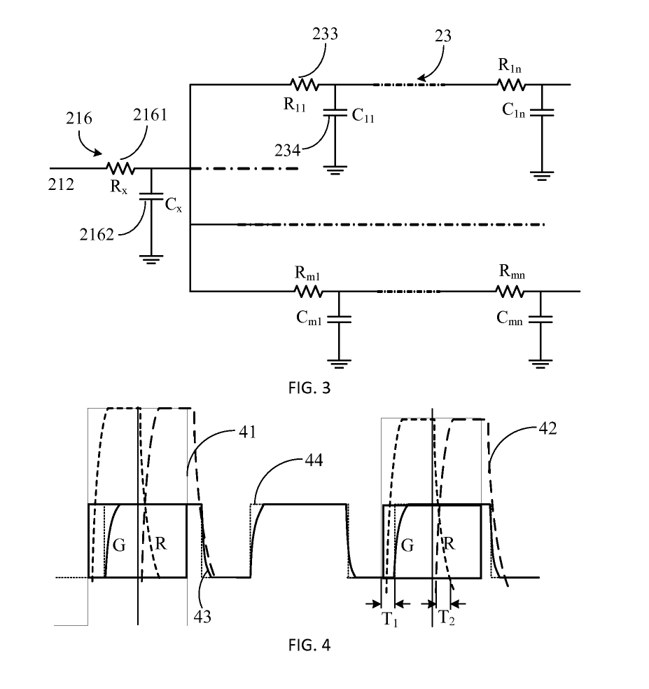

FIG. 3 is an equivalent circuit of the impedance unit and the scanning line of the scanning driven circuit in accordance with the first embodiment. As shown, the impedance unit 216 includes at least one resistor 2161 and at least one capacitor 2162. The scanning line 23 includes a plurality of resistors 233 and capacitors 234. One end of the resistor 2161 couples with the VGH transmission line 212, and the other end of the resistor 2161 couples with a first end of the capacitor 2162 and the resistor 233 of the scanning lines 23. A second end of the capacitor 2162 is grounded. The product of the resistor 2161 and the capacitor 2162 of the impedance unit is lamer than that of the resistor 233 and the capacitors 234 of the scanning line 23. The value of the resistor 2161 is Rx, the value of the capacitor 2162 is Cx, the values of the resistors 233 of the scanning lines 23 are R11, . . . R1n, . . . , Rm1, . . . , Rmn, and the values of the capacitors 234 of the scanning lines 23 are C11 . . . C1n, . . . , Cm1, . . . , Cmn. The above values satisfy the equation below:

Rx*Cx [symbol] R11*C11+ . . . +R1n*C1n+ . . . +Rm1*Cm1+ . . . +Rmn*Cmn

When the above equation is satisfied, the values of the resistor 233 and the capacitors 234 of the scanning lines 23 can be omitted. That is, the delay of the front end 231 and the resistor 233 are mainly affected by the resistor 2161 and the capacitor 2162 of the impedance unit 216. As such, the delay of the scanning driven signals at the front end 231 is substantially the same with that of the scanning driven signals at the rear end 232.

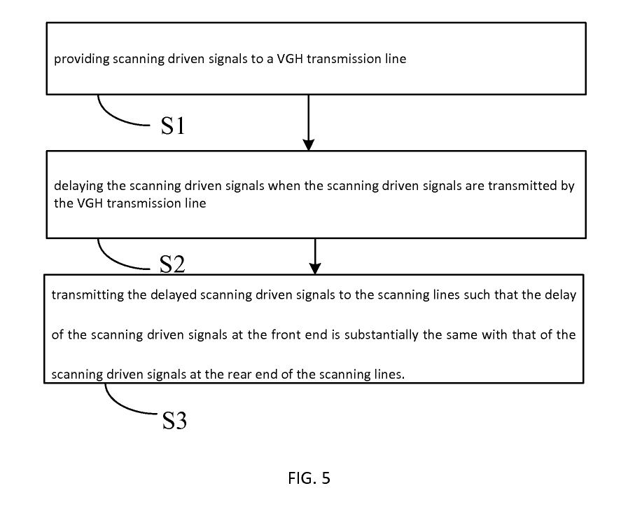

FIG. 4 is a waveform diagram of the active matrix display having the impedance unit 216. The ideal waveform of the scanning driven signals is depicted by the solid line 41. The waveform of the data driven signals of the data lines 24 is depicted by the solid line 43. The ideal waveform of the data driven signals of the data lines 24 is depicted by the dashed line 44.

Also referring to FIG. 2, the fan-shaped design of the data lines 24 cause the delay of the data driven signals at two lateral side of the active, matrix display 20. The delay time of the data driven signals is T1, which results in that the G pixels arranged at the lateral sides of the active matrix display 20 are not charged within T1. As such, the charging time of the pixel G is shorter than that of the pixel R. After incorporating the impedance unit 216, the delay of the front end 231 and the resistor 233 are substantially the same, which are both T2. The charging time of the G pixels is prolonged and that of the R pixel is shorted. Thus, the impedance unit 216 improves the color shift caused by the delay of the scanning lines 23 and the data lines 24.

in one embodiment, the impedance unit 216 is one circuit including at least one resistor, and the resistance value of the resistor is larger than the resistor of the scanning lines. In other embodiments, the impedance unit 216 is one circuit including at least one capacitor, and the capacitance value of the capacitor is larger than the capacitor of the scanning lines.

In one embodiment, the impedance unit 216 is arranged within the PCBA 211 as indicated by “A” in FIG. 2. In other embodiment, the impedance unit 216 is arranged within the scanning driven chip 213 as indicated by “C” in FIG. 2.

FIG. 5 is a flowchart of the scanning driven method in accordance with a second embodiment. The method includes the following steps. In step S1, the scanning driven signals are provided to VGH transmission line 212. Specifically, the timing control unit 214 generates control signals (GVON/GVOFF) to control the PWM unit 215, The PWM unit 215 receives the voltage (VGHF) from the PCBA 211 and the control signals from the timing control unit 214, and then modulates and outputs the scanning driven signals

In step S2, the VGH transmission line delays the scanning driven signals during transmission. Specifically, the VGH transmission line 212 further includes an impedance unit to delay the scanning driven signals.

In step S3, the delayed scanning driven signals are transmitted the scanning lines such that the delay of the scanning driven signals at the front end is substantially the same with that of the scanning driven signals at the rear end 232 of the scanning lines.

In view of the above, by arranging the impedance unit, the scanning driven signals are delayed to maintain the delay of the scanning driven signals at the front end and rear end the same. As such, the color shift effect is improved.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A scanning driven circuit for providing scanning driven signals to scanning lines of an active matrix display, comprising:
a printed circuit board assembly (PCBA);
a scanning driven chip;
a voltage high (VGH) transmission fine for transmitting the scanning driving signals from the PCBA to the scanning driven chip; and
wherein the VGH transmission line comprises an impedance unit to maintain a delay of the scanning driving signals at the front end substantially the same with the delay of the scanning driving signals at the rear end of the scanning line.

2. The scanning driven circuit as claimed in claim 1, wherein the impedance unit is arranged on the VGH transmission line within the PCBA.

3. The scanning driven circuit as claimed in claim 1, wherein the impedance unit is arranged on the VGH transmission line between the PCBA and the scanning driven chip.

4. The scanning driven circuit as claimed in claim 1, wherein the impedance unit is arranged on the VGH transmission line within the scanning driven chip.

5. The scanning driven method as claimed in claim 1, wherein the impedance unit is a circuit having at least one resistor, and the resistance value of the resistor is larger than the resistor of the scanning lines.

6. The scanning driven circuit as claimed in claim 1, wherein the impedance unit is a circuit having at least one capacitor, and the capacitance value of the capacitor is larger than the capacitor of the scanning lines.

7. The scanning driven circuit as claimed in claim 1, wherein the impedance unit comprises at least one resistor and at least one capacitor, and a product of the resistor and the capacitor of the impedance unit is larger than that of the resistor and the capacitors of the scanning line.

8. An active matrix display, comprising;
a scanning driven circuit for providing scanning driven signals to scanning lines of an active matrix display, and the scanning driven circuit comprises:
a PCBA;
a scanning driven chip;
a VGH transmission line for transmitting the scanning driving signals from the PCBA to the scanning driven chip; and
wherein the VGH transmission line comprises an impedance unit to maintain a delay of the scanning driving signals at the front end substantially the same with the delay of the scanning driving signals at the rear end of the scanning line.

9. The active matrix display as claimed in claim 8, wherein the impedance unit is arranged on the VGH transmission line within the PCBA.

10. The active matrix display as claimed in claim 8, wherein the impedance unit is arranged on the VGH transmission line between the PCBA and the scanning driven chip.

11. The active matrix display as claimed in claim 8, wherein the impedance unit is arranged on the VGH transmission line within the scanning driven chip.

12. The scanning driven method as claimed in claim 8, wherein the impedance unit is a circuit having at least one resistor, and the resistance value of the resistor is larger than the resistor of the scanning lines.

13. The active matrix display as claimed in claim 8, wherein the impedance unit is a circuit having at least one capacitor, and the capacitance value of the capacitor is larger than the capacitor of the scanning lines.

14. The active matrix display as claimed in claim 8, wherein the impedance unit comprises at least one resistor and at least one capacitor, and a product of the resistor and the capacitor of the impedance unit is larger than that of the resistor and the capacitors of the scanning line.

15. A scanning driven method, comprising:
providing scanning driven signals to a VGH transmission line,
delaying, the scanning, driven signals when the scanning driven signals are transmitted by the VGH transmission line; and
transmitting the delayed scanning driven signals to the scanning hoes such that the delay of the scanning driven signals at the front end is substantially the same with that of the scanning driven signals at the rear end of the scanning lines.

16. The scanning driven method as claimed in claim 15, wherein the delaying step further comprises arranged an impedance unit on the VGH transmission line.

17. The scanning driven method as claimed in claim 16, wherein the impedance unit comprises at least one resistor and at least one capacitor, and a product of the resistor and the capacitor of the impedance unit is larger than that of the resistor and the capacitors of the scanning line.
